(19) United States
(12) Patent Application Publication
(10) Pub. No.: US 2007/0170201 A1
(43) Pub. Date: Jul. 26, 2007

(54) Propane tank vending machine assembly

(76) Inventor: Lowell George Steffens, Hale, MI (US)

Correspondence Address: FRASER CLEMENS MARTIN & MILLER LLC, 28366 KENSINGTON LANE, PERRYSBURG, OH, 43551, US

(21) Appl. No.: 11/488,256

(22) Filed: Jul. 18, 2006

Related U.S. Application Data
(63) Continuation-in-part of application No. 10/768,349, filed on Jan. 30, 2004, now Pat. No. 6,853,905.
(60) Provisional application No. 60/443,753, filed on Jan. 30, 2003.

(51) Int. Cl. B65G 59/00; B65H 3/00

(52) U.S. Cl. 221/265

(57) ABSTRACT

A propane tank vending assembly includes a vending machine an enclosure having closed sides and a hollow interior, and a door opening formed in one of the sides. The vending machine includes at least one door member releasably closing the door opening for accessing a propane tank and an actuator operable to allow an article to be vended from the door member. The assembly also includes a payment control unit connected to the vending machine by a connector. The payment control unit includes a customer interface, a controller and a means for receiving payment. The controller is operable to receive a signal from the customer interface and process a signal from the means for receiving payment and to send a signal to the actuator on the vending machine to allow a propane tank to be vended from the door member.

### CROSS-REFERENCE TO RELATED APPLICATION

This application is a continuation-in-part of co-pending U.S. patent application Ser. No. 10/768,369, filed on Jan. 30, 2004, which claims the benefit of U.S. Provisional Patent Application Ser. No. 60/443,753 filed Jan. 30, 2003.

### BACKGROUND OF THE INVENTION

The present invention relates generally to vending and dispensing machines and in particular to such a machine for vending a plurality of relatively large articles, such as propane storage tanks.

Standard valved cylinders for propane gas, such as the type typically used for outdoor grilles, pose vending problems. These cylinders have a cylindrically shaped tank, a base mounted to the bottom of the tank, a valve at the top of the tank, and a guard substantially encircling the valve and providing a pair of lifting handles. The base and the guard have diameters smaller than the diameter of the outer surface of the tank. These standard propane cylinders can be relatively heavy, at least 20 pounds, and difficult for some customers to lift and manipulate.

The U.S. Pat. No. 1,530,288 shows a vending machine for cylinders of compressed gas and fluid. The machine includes an outer cabinet having an opening in the top of the cabinet, an opening at the bottom of the cabinet, and a serpentine passage for horizontally oriented cylinders within the cabinet extending from the top opening to the bottom opening. An empty cylinder is placed in the top opening and a crank arm is rotated which inserts the empty container into the cabinet and moves the container forward into the passage to release a full container out the bottom opening. This machine would require an unreasonable amount of lifting and manipulation of a standard propane cylinder. Accordingly, there is a need in the art for an improved vending machine for valved cylinders of compressed gas.

The U.S. Pat. No. 4,778,042 shows a vending machine for cylinders of compressed gas. The machine includes an outer cabinet having a door opening, a storage chain conveyer for horizontally oriented cylinders within the cabinet, and a rotatable transfer cradle between the door opening and the conveyer which prevents access to the conveyor. The transfer cradle is provided with sensors so that a data processor can identify an empty cylinder placed in the transfer cradle through the door opening. Thereafter, the transfer cradle and conveyor are operated to load the empty cylinder into the conveyor and to unload a full cylinder from the conveyor into the transfer cradle for extraction through the door opening. This machine is relatively complex and expensive to produce. Additionally, this machine would require an unreasonable amount of lifting and manipulation of a standard propane cylinder.

The U.S. Pat. No. 5,829,630 shows a propane cylinder vending machine having a cabinet with first and second openings sized to allow the valved cylinders to pass therethrough in an upright orientation. A conveyor is provided within the cabinet, which extends from the first opening to the second opening to move the cylinders therebetween. The conveyor supports the cylinders in an upright orientation. An empty cylinder verification system and an anti-theft system having mechanically inner and outer doors are provided.

It remains desirable to provide an effective and efficient vending machine for vending articles including propane tanks and the like that allows only a single article to be dispensed at the time of vending while also allowing exchange of the articles and preventing theft of the articles.

It also remains desirable to provide an effective and efficient vending machine in conjunction that provides an option of purchasing or exchanging articles while also providing various payment options for potential customers of the articles.

### SUMMARY OF THE INVENTION

The present invention concerns a propane tank vending machine that includes a generally rectangular box-shaped frame enclosed except at a front side, the sides defining an interior portion of an enclosure. The vending machine includes a rotator assembly rotatably mounted in the interior of the enclosure, the rotator assembly being operable to receive a plurality of propane tanks. A door member is hingedly attached to the frame at the front side. The door member is connected to an indexing assembly that is operable to rotate the rotator assembly when the door member is moved from a door closed position to a door open position. The rotator assembly is configured to present only one storage location at a time when the door is open.

In a preferred embodiment, the rotator assembly has three trays vertically stacked and each tray has eight storage locations defined by dividers. The indexing assembly includes a first arm for enabling the rotator assembly to rotate and a second arm for rotating the rotator assembly. The rotator assembly has a plurality of apertures formed therein each corresponding to one of the storage locations and the indexing assembly includes a pin for selectively engaging the apertures to prevent rotation of the rotator assembly. The rotator assembly also includes a lever arm mounting the pin, the lever arm being in a normal position with the pin engaging one of the apertures when the door member is in the closed position and the lever arm being moved by engagement with the first arm to a released position disengaging the pin from the one of the apertures. The rotator assembly further includes a plurality of projections, the second arm engaging one of the projections during an opening of the door member to rotate the rotator. assembly.

The present invention also concerns a propane tank vending machine assembly that includes an apparatus for vending a plurality of articles comprising at least one vending machine including an enclosure having closed sides and a hollow interior, the enclosure having a door opening formed in one of said sides, a rotator assembly rotatably mounted in the hollow interior of the frame where the rotator assembly has a plurality of angularly spaced storage locations each for releasably retaining an article to be vended, at least one door member releasably closing the door opening for accessing an article to be vended and an actuator operable to allow an article to be vended from the at least one door member; and a payment control unit connected to the at least one vending machine by a connector, the payment control unit including a customer interface, a controller and at least one means for receiving payment, where the controller is in communication with the customer interface and the at least one means for receiving payment, the actuator and the controller operable to receive a signal from the customer interface and process a signal from the means for receiving payment and to send a signal to the actuator on the at least one vending machine to allow an article to be vended from the at least one door member.

### DESCRIPTION OF THE DRAWINGS

The above, as well as other advantages of the present invention will become readily apparent to those skilled in the art from the following detailed description of a preferred embodiment when considered in the light of the accompanying drawings in which:

FIG. 1 is a fragmentary perspective view of a vending machine in accordance with the present invention shown in a door closed position;

FIG. 2 is an exploded fragmentary view of the vending machine shown in FIG. 1 in a door open position;

FIG. 3 is an enlarged exploded perspective view of the indexing and rotating assembly shown in FIG. 2;

FIG. 4 is a perspective bottom view of the lower tray of the rotator assembly shown in FIG. 2;

FIG. 5 is a schematic view of a propane tank vending machine assembly in accordance with the present invention; and

FIG. 6 is a perspective view of the propane tank vending machine assembly of FIG. 5.

### DESCRIPTION OF THE PREFERRED EMBODIMENT

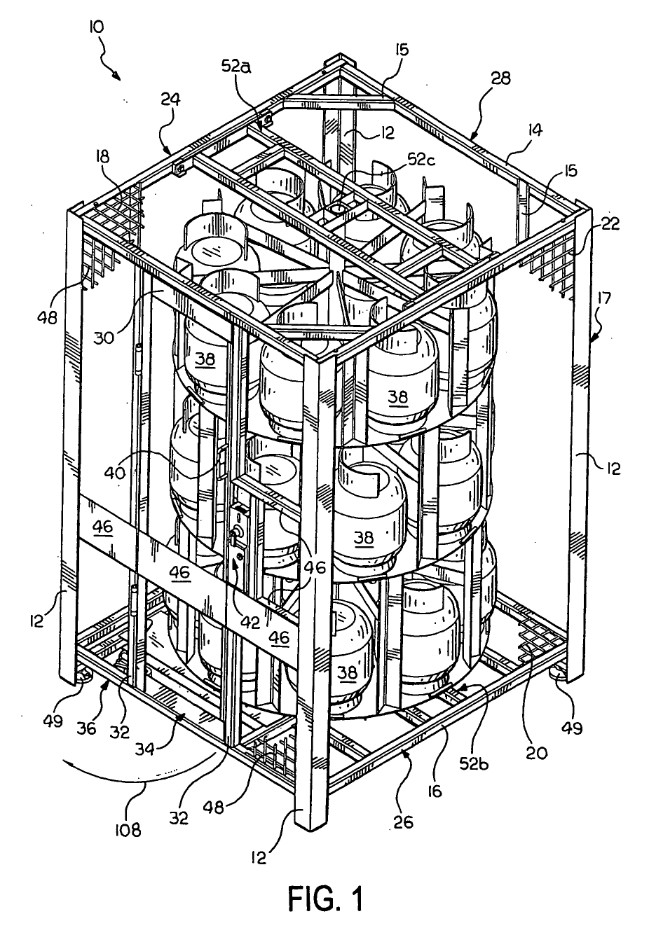

Referring now to FIG. 1, a propane tank vending machine or unit in accordance with the present invention is indicated generally at 10. The propane tank vending machine 10 includes a plurality of vertical support members 12 extending between a generally square or rectangular upper frame 14 and a generally square or rectangular lower frame 16, forming a generally rectangular box-shaped frame, indicated generally at 17. The upper frame includes a plurality of bracing members 15 extending across corners of the upper frame 14 to provide stiffness and support thereto. A generally planar overhead or top member 18 and a generally planar base member 20 extend across the upper frame 14 and the lower frame 16, respectively, to enclose a top and a bottom respectively of the vending machine 10. A wall 22 is representative of walls extending between pairs of the support members 12 and the frames 14 and 16 to enclose a left side 24, a right side 26, and a rear side 28 of the vending machine 10. Preferably, the top member 18, the base member 20, and the walls 22 are constructed of a wire mesh material or the like. The top member 18, the base member 20, and the walls 22 enclose five of the six planar surfaces of the vending machine 10 while advantageously allowing users of the vending machine 10 to view the contents thereof.

A door member 30 is hingedly mounted along one vertical edge to a one of two spaced vertical door frame members 32 to enclose a door opening 34 between the door frame members 32 on a front side 36 of the vending machine 10. The door frame members 32 extend between the upper frame 14 and the lower frame 16 at the front side 36 of the vending machine 10. The width of the door opening 34 is sized to allow a standard-sized propane tank 38 aligned therewith to pass therethrough. The open space between each of the door frame members 32 and the adjacent support member 12 is such that a standard-sized propane tank 38 will not pass therethrough. The door member 30 includes a handle 40 attached to an exterior surface thereof for moving the door member 30 between closed and open positions as discussed in more detail below. A locking mechanism 42 is attached to a plurality of frame members 44 on the front side 36 of the vending machine 10 adjacent the door member 30. The locking mechanism 42 is preferably a coin or token operated locking device, such as one commercially available from Monarch Coin & Security, Inc., Covington, Ky., or similar device, to allow for limited access to the vending machine 10.

A plurality of horizontal support members 46 extend between the support members 12 and the door frame members 32 for providing stiffness and support to the vending machine 10. The spaces formed between the support members 12, the door frame members 32, the frame members 44, and the horizontal support members 46 is enclosed by a plurality of walls 48, each of which are preferably constructed of a wire mesh material similar to the top member 18, the base member 20, and the walls 22 to enclose the vending machine 10 while advantageously allowing users of the vending machine 10 to view the contents thereof. A stabilizer foot 49 is attached to a lower end of each of the support members 12 to provide stability to the vending machine 10. The stabilizer foot 49 may include a conventional vertical threaded fastener for leveling the vending machine 10. Alternatively, a conventional caster with a foot-operated lock could be substituted for the ground engaging portion of the foot 49.

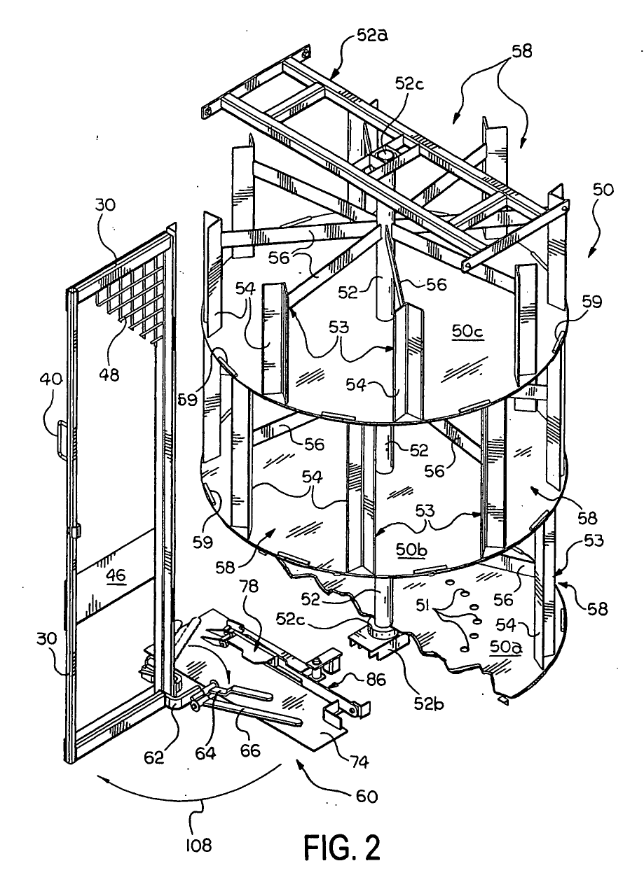

Referring now to FIGS. 1 and 2, a rotator assembly, indicated generally at 50, is disposed in an interior of the above-described enclosure of the vending machine 10 and includes a generally disk-shaped first or lower tray 50a, a generally disk-shaped second or middle tray 50b, and a generally disk-shaped third or upper tray 50c. Each of the trays 50a, 50b and 50c is fixedly mounted at a central aperture thereof on a vertical shaft member 52. The shaft member 52 is rotatably mounted at opposite ends to the upper frame 14 by an upper support assembly 52a, extending across the upper frame 14 between the sides 24 and 26, and to a similar lower support assembly 52b attached to the lower frame 16. Preferably, each of the support assemblies 52a and 52b includes a bearing 52c disposed therein to allow the shaft member 52 to rotate. Each of the trays 50a, 50b, and 50c is adapted to receive a plurality of propane tanks 38, best seen in FIG. 1. Each of the tanks 38 rests in an upright position on an upper surface of one of the trays, 50a, 50b or 50c, between an adjacent pair of a plurality of spaced apart retaining members or dividers 53 extending upwardly from the upper surfaces of the trays 50a, 50b, or 50c. Each of the dividers 53 includes a substantially vertical beam 54 mounted adjacent a periphery of the associated one of the trays 50a, 50b, or 50c and a horizontal beam 56 extending between the shaft 52 and an upper portion of the vertical beam 54. Preferably, the dividers 53 are evenly spaced apart in a circle extending around the shaft 52 to define a plurality of tank storage locations 58 each sized to receive one of the standard-size propane tanks 38. Each of the trays 50a, 50b and 50c is sized for eight of the storage locations 58 for a total of twenty-four. Each storage location 58 is further defined by a stop 59 extending upwardly from the upper surface of the associated tray 50a, 50b and 50c. The stops 59 are disposed substantially equidistant between the dividers 53 that define each of the storage locations 58 and are attached at the periphery of the associated tray. Alternatively, any suitable number of dividers 53 can be used depending upon the diameter of the trays 50a, 50b and 50c and the size of the objects to be vended. Preferably, when the trays 50a, 50b, and 50c are attached to the shaft member 52, the mounting locations 58 are vertically staggered or offset such that only one of the storage locations 58 is accessible through the door opening 34 at a time as discussed in more detail below.

The lower tray 50a includes a plurality of equally radially spaced apertures 51 extending therethrough. The apertures 51 are equal in number to the total number of tank storage locations 58 on the rotator assembly 50. An indexing and rotating assembly, indicated generally at 60, is attached to a lower portion of the door member 30. The assembly 60 is operable to rotate the rotator assembly 50 from one aperture 51 to the next aperture 51 each time the door member 30 is moved from the closed position, shown in FIG. 1, to the open position, shown in FIG. 2.

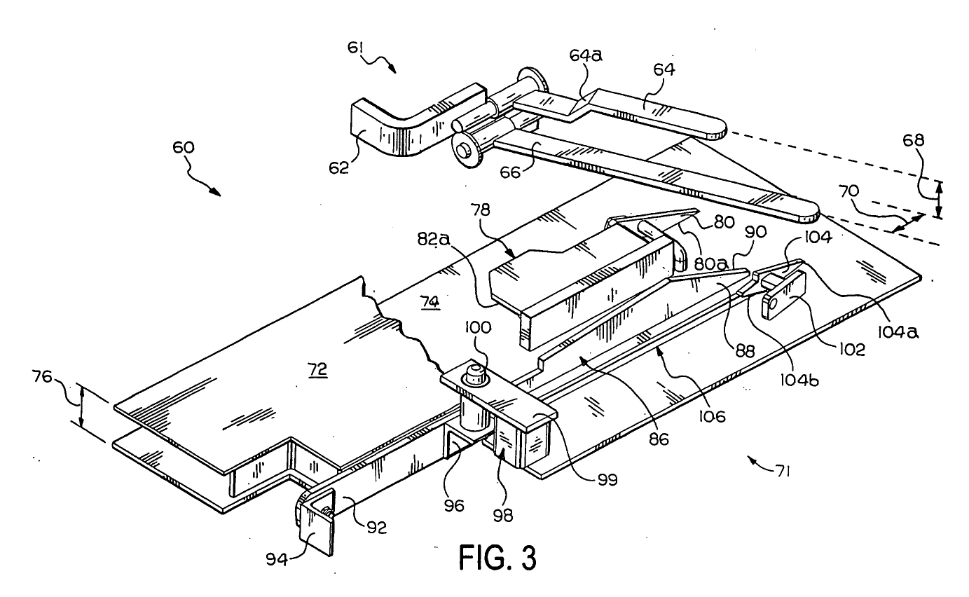

Referring now to FIG. 3, the indexing and rotating assembly 60 is shown in greater detail. The assembly 60 includes a rotating assembly, indicated generally at 61, having a generally L-shaped base 62 attached to a lower portion of the door member 30. When the door member 30 is moved from the closed position to the open position, the base 62 moves with it. An upper swing arm 64 and a lower swing arm 66 are attached to and extend outwardly from a portion of the base 62 adjacent the inner surface of the door member 30. The upper swing arm 64 preferably includes an offset portion 64a. The swing arms 64 and 66 are spaced apart vertically on the base 62 by a distance indicated by an arrow 68. The respective longitudinal axes of the swing arms 64 and 66 are spaced apart horizontally by a distance indicated by an arrow 70. The assembly 60 also includes a fixed assembly, indicated generally at 71, having an upper plate 72, partially cut away, and a lower plate 74 spaced apart as indicated by an arrow 76. The upper plate 72 and the lower plate 74 are each attached to the lower frame 16 by any suitable means such as by fasteners, a welded connection, or the like.

A guide member 78 includes a ramped portion 80 and a horizontal planar portion 82. The ramped portion 80 is pivotally attached to the upper plate 72. The planar portion 82 is fixedly attached to a support member 84 extending upwardly from the upper. plate 72 and is disposed above the upper plate 72 by a predetermined distance. An angled surface 80a of the ramped portion 80 is adapted to rest on an upper surface of the upper plate 72.

A lever arm 86 includes a free first end 88 having a ramped surface 90 and a second end 92 pivotally attached to the lower frame 16 by an attachment bracket 94. A pin assembly 98 includes a pin support 96 that extends outwardly from the lever arm 86 intermediate the first end 88 and the second end 92. The pin assembly 98 also includes a pin guide 99 attached to the lower frame 16 and a pin 100 mounted on the pin support 96 and extending upwardly through an aperture in the pin guide 99. A spring (not shown) biases the pin 100 in an extended position shown in FIG. 3. In the extended position, the pin 100 engages with a one of the apertures 51 formed in the lower tray 50a, preventing the rotator assembly 50 from rotating. A bracket 102 is attached to the lower plate 74 adjacent the lever arm 86 and includes a ramp 104 pivotally attached thereto. The ramp 104 includes a forward ramped surface 104a and a rear ramped surface 104b. A groove 106 is formed in the lower plate 74 below the lever arm 86 and is sized to permit the lever arm 86 to pass therethrough.

When the door member 30 is moved from moved from the closed position (FIG. 1) to the open position (FIG. 2), the swing arms 64 and 66 of the rotating assembly 61 move in a direction indicated by an arrow 108, best seen in FIG. 2. As the assembly 61 moves, the lower swing arm 66 first engages with the ramp 104 and begins to travel up the forward ramped surface 104a and then engages the ramped surface 90 of the lever arm 86. As the assembly 61 continues to move, the swing arm 66 begins to displace the lever arm 86 downwardly under the influence of gravity and the lever arm 86 pivots about the second end 92 attached to the attachment bracket 94. The lever arm 86 displaces downwardly into the groove 106 and, as the lever arm 86 moves downwardly, the pin 100 is retracted from the aperture 51 through the aperture in the pin guide 99. Now the rotator assembly 50 is free to rotate.

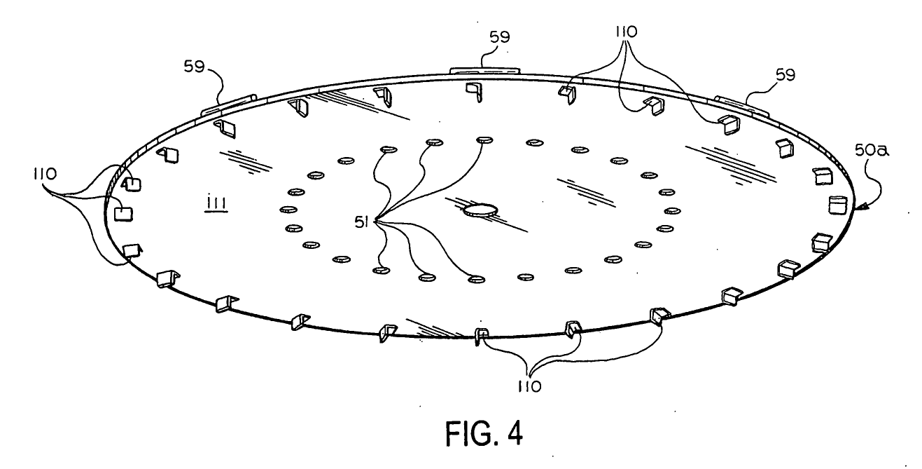

After the lower swing arm 66 engages the ramped surface 90 of the lever arm 86, and as the rotating assembly 61 continues to move, the upper swing arm 64 later engages with and travels up the ramped portion 80 of the guide member 78 and engages the planar portion 82 of the guide member 78. When the upper arm 64 engages with the planar portion 82, the upper arm 64 is disposed directly below the lower tray 50a. At or near the same time as the lower arm 66 moves the pin 100 downwardly, the upper arm 64 engages with a one of a plurality of projections 110, best seen in FIG. 4, extending downwardly from a lower surface 111 of the lower tray 50a. The number of the projections 110 corresponds to the number of apertures 51 and to the number of mounting locations 58 on the rotator assembly 50. As the upper arm 66 engages the projection 110, the lower arm 64 has moved the lever arm 86 downwardly into the groove 106 and moved the pin 100 downwardly, which disengages the pin 100 from the aperture 51 and allows the rotator assembly 50 to rotate. The force utilized to move the door member 30, therefore, is utilized to rotate the rotator assembly 50 when the upper arm 66 engages the projection 110.

Assuming the rotating assembly 61 continues to move in the direction 108, the upper arm 64 continues to move the rotator assembly 50 until the upper arm 64 reaches a trailing edge 82a of the planar portion 82 of the guide member 78. When the upper arm 64 reaches the trailing edge 82a, the arm 64 drops to an upper surface of the lower plate 72, disengaging from the projection 110 and ceasing to rotate the rotator assembly 50. At or about the same time as the upper arm 64 drops, the lower arm 66 reaches a point in its travel in the direction 108 where it disengages from the lever arm 86. When the lower arm 66 disengages from the lever arm 86, the spring (not shown) returns the lever arm to its rest position, and the pin 100 returns to the extended position. The predetermined distance traveled by the rotator assembly 50 is such that when the pin 100 returns to the extended position, the pin 100 engages with the next aperture 51 that adjacent to the one of the apertures 51 from which it had previously been disengaged. The pin 100, when engaged in a one of the apertures 51 prevents the rotator assembly 50 from being rotated and prevents the removal of more than one of the propane tanks 38 while the door member 30 is open.

The door member 30 is fully opened at substantially 90° from the closed position. The assembly 60 allows the rotator assembly 50 to rotate only a predetermined angular distance when the door member 30 is moved from the fully closed position to the fully open position. The assembly 60 also prevents movement of the rotator assembly 50 while the door member 30 remains open. With the configuration shown, each time the door 30 is opened, the indexing and rotating assembly 60 will rotate the rotator assembly 50 15°.

While the present invention has been described wherein the rotator assembly 50 is rotated 15°, those skilled in the art will realize that the configuration may be altered to rotate the assembly 50 for any desired radial angle depending on the size and the number of the articles to be vended.

Preferably, the locking mechanism 42 is coin-operated or token-operated wherein the door member 30 may be opened only when a coin(s) or token(s) is inserted into the locking mechanism 42 thereby permitting unattended operation. The propane tank vending machine 10 is capable of dispensing filled propane cylinders 38 and is also advantageously capable of exchanging an empty single cylinder 38 for a single full cylinder 38. Preferably, the door member 30 includes a spring-loaded device (not shown) or similar device such that if the door member 30 is left open, it will close on its own.

Furthermore, the propane tank vending machine 10 is designed to permit an authorized person to insert a “hand held” tool when the door member 30 is opened to depress the lever arm 86 thereby disengaging the pin 100 and allowing free rotation of the rotator assembly 50 for loading and unloading the cylinders 38.

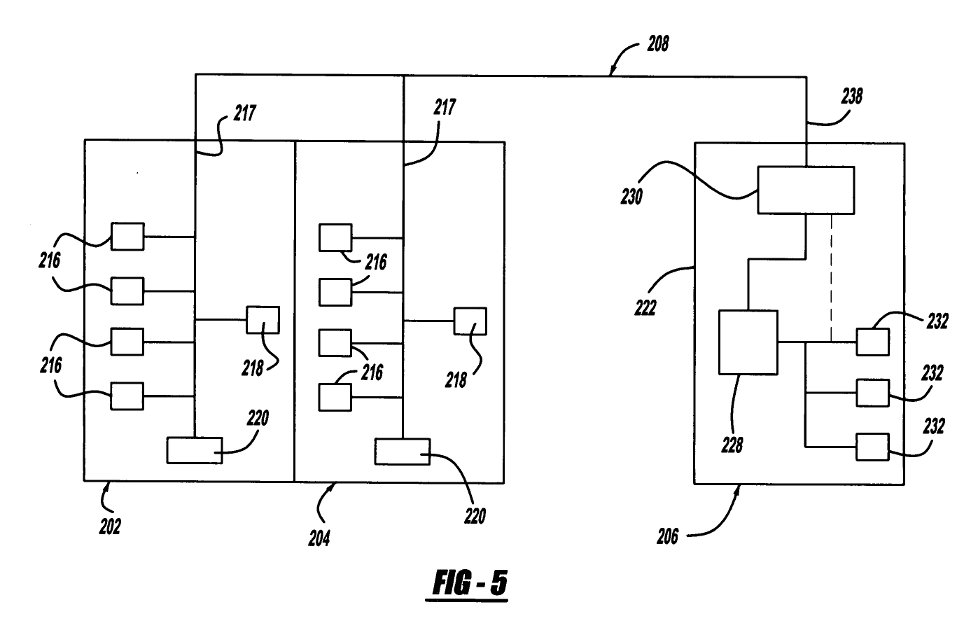

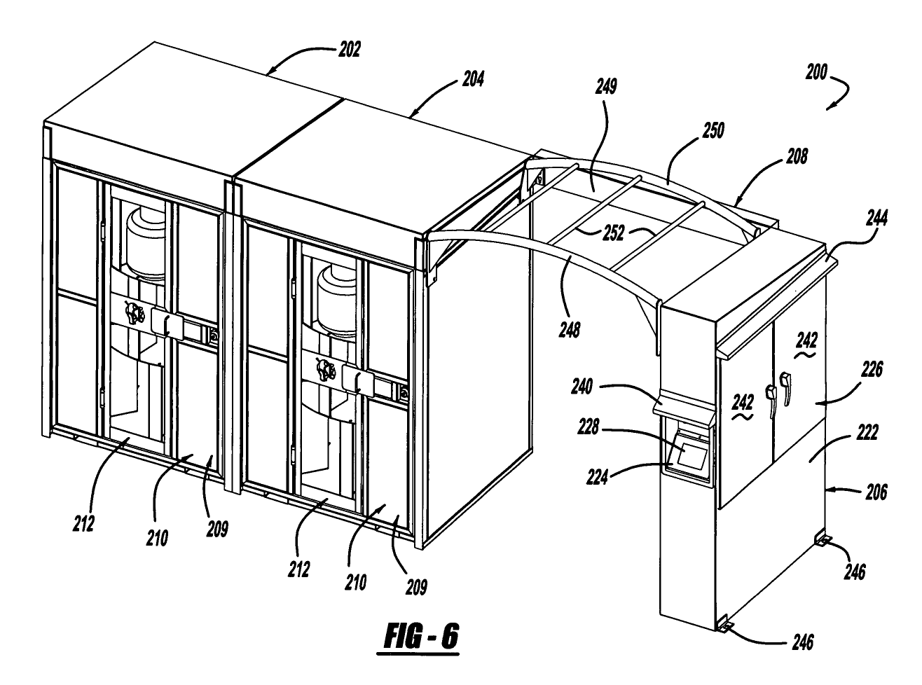

Referring now to FIGS. 5 and 6, a propane tank vending machine assembly in accordance with the present invention is indicated generally at 200. The assembly 200 includes at least a first propane tank vending machine 202. Additional vending machines may be joined with the first propane tank vending machine 202 as needed. A second propane tank vending machine 204, similar to, for example, the propane tank vending machine 10 shown in FIGS. 1-4 is shown adjacent to the first propane tank vending machine 202. While illustrated with a pair of vending machines, those skilled in the art will appreciate that more or fewer vending machines may be utilized while remaining within the scope of the present invention. Each vending machine 202 and 204 are connected to a payment control cabinet or unit 206 via at least one bridge or connector member 208. The assembly 200 is adapted to be fixedly mounted to both a planar mounting surface (not shown) and to a perpendicular planar adjacent wall (not shown) to provide a theft deterrent and robust mounting of the assembly 200. The mechanical and electronic components of the assembly 200 are preferably robust and corrosion resistant, as the assembly 200 is contemplated to be installed and maintained out of doors and in the elements.

The vending machines 202 and 204 are each adapted to enclose a plurality of propane tank cylinders 38 disposed therein, similar to the vending machine 10 of FIGS. 1-4 and are preferably arranged on a plurality of levels on a rotating assembly, such as the levels 50a, 50b, and 50c of the rotator assembly 50 shown in FIGS. 1-4. Alternatively, a fewer number or a greater number of levels may be utilized while remaining within the scope of the present invention. The vending machines 202 and 204 each include a door assembly 209 that includes a maintenance door 210 and a customer door 212, best seen in FIG. 6. The customer door 212 is smaller than the maintenance door 210 and is connected to and disposed within the maintenance door 210 such that the customer door 212 is opened or closed when the maintenance door 210 is opened or closed. The customer door 212 includes an electric locking device to allow access to only a small portion of the interior of the vending machine 202 or 204, similar to the door 30 of the vending machine 10. The larger maintenance door 210 includes a manual locking device to allow access to a large portion of the interior of the vending machine 202 or 204, such as for installation and removal of a large number of the cylinders 38. Alternatively, the maintenance door 210 or the customer door 212 includes a locking mechanism similar to the locking mechanism 42 shown in FIG. 1.

The vending machines 202 and 204 include a plurality of sensors 216 disposed therein, best seen in FIG. 5. The sensors 216 are in communication with the control unit 206 and the connector 208 via a conduit 217. The sensors 216 can include, but are not limited to, a proximity sensor, a door open sensor, or actuating sensor. Preferably, each of the tank storage locations 58 includes a sensor to indicate the presence of a cylinder 38 and the status of the cylinder 38. The vending machines 202 and 204 also include a lock actuator 218 for alternately engaging and disengaging a lock for the customer door 212 and a motor 220 for rotating the rotating assembly of each of the vending machines 202 and 204. The motor 220 is preferably a reversible electric motor. The actuator 218 and the motor 220 are each in communication with the control unit 206 and the connector 208 via the conduit 217.

The payment control cabinet or unit 206 includes a housing 222 for containing a payment processing area 224 and a maintenance or service area 226, best seen in FIG. 6. The payment processing area 224 includes a customer interface 228 such as a touch screen or the like that is in communication with a controller 230, such as a programmable logic controller (PLC), a PC, or the like, located in the maintenance area 226. The touch screen 228 is in communication with a credit card reader 232 and a printer 234 disposed in the payment processing area 224. Alternatively, the touch screen 228 is also in communication with a cash, coin, or token collector 236 also disposed in the payment processing area 224. The controller 230 includes memory storage as well as a processor for accepting and processing signals from the sensors 216, the touch screen 228, and the credit card reader 232, for generating signals to the actuators 218, the motors 220, and the printer 234 and for running a program to generate a user interface on the touch screen 228. The controller 230 is in communication with the connector 208 via a conduit 238.

The payment processing area 224 includes a shield 240 to protect the touch screen 228 from the elements and to provide shade to increase the visibility of the touch screen 228 for the customer. The maintenance area 226 includes at least one door 242 for accessing and maintaining the various components (such as the controller 230, the credit card reader 232, and the printer 234) of the control unit 206. A gutter 244 or similar device protects the components when the doors 242 are open. The housing 222 includes brackets 246 on a lower portion thereof for attaching the housing 222 to a mounting surface.

The bridge or connector member 208 includes a pair of preferably arched extension members 248 and 250 and a main lateral support member 249 extending between the payment control unit 206 and the vending machines 202 and 204. The extension members 248 and 250 are preferably tubular in cross section and at least one of the extension members 248 and 250 functions to both provide lateral support between the unit 206 and the vending machine 204, as well as define a conduit for enclosing conductors or the like for transmitting signals between the controller 230 of the unit 206 and the vending machines 202 and 204. While a pair of members 248 and 250 is illustrated, one member or more than two members may be utilized while remaining within the scope of the present invention, as will be appreciated by those skilled in the art. The connector 208 includes a plurality of cross supports 252 extending between the extension members 248 and 250. In an alternative embodiment, the control unit 206 could be mounted directly to one of the vending machines 202 or 204 and the connector 208 would be an electrical connector only, while remaining within the scope of the present invention. Preferably, the actuators 218 and the motors 220 are operable to send a signal to the controller 230 to indicate their operational status.

The assembly 200 advantageously allows a customer (not shown) to either purchase or exchange a propane cylinder 38. Alternatively, the assembly 200 may be configured to only allow a customer to purchase a propane cylinder 38. An appropriate selection is provided on the touch screen 228. When a customer wishes to purchase or exchange a propane cylinder 38, the customer initiates the user interface program and enters the choice of purchase or exchange at the touch screen 228. The customer then enters a payment through the credit card reader 232 or the cash, coin, or token collector 236. The controller 230 then verifies the payment by any typical payment verification process, such as by connecting to a network or the like (not shown) to verify the credit card. Based on the choice of purchase or exchange and the verified payment, the controller 230 processes and sends commands via the connector 208 to the vending machines 202 or 204. Preferably, the controller 230 has stored information about the location and status each of the cylinders 38 and each of the tank storage locations 58 in the machines 202 and 204.

For example, if the customer chooses to exchange a cylinder 38, the controller 230 will determine an open tank storage location 58, send a signal to the motor 220 to rotate the rotator assembly 50 such that the open location 58 is adjacent the customer door 212 and will send another signal to the actuator 218 to allow the customer to open the customer door 212 and place the cylinder 38 to be exchanged in the machine 202 or 204. After the customer has placed the empty cylinder 38 to be exchanged in the open location 58 and closed the customer door 212 and the controller 230 has verified the placement of the empty cylinder 38 and the door 212 closed, the controller 230 will determine the next cylinder 38 to be vended, based on its date and time of installation as stored in the memory of the controller 230. The controller 230 will then send a signal to the motor 220 to rotate the rotator assembly 50 of the vending machine 202 or 204 such that the location 58 of the next determined cylinder 38 is adjacent the customer door 212 and will send another signal to the actuator 218 to allow the customer to open the customer door 212 and remove the cylinder 38. Preferably, each of the vending machines 202 and 204 include a means for preventing rotation of the rotator assembly 50 while the customer door 212 is open such as, but not limited to, the pin 100 of the vending machine 10 shown in FIGS. 1-4.

Similarly, if the a customer wishes to purchase a full propane cylinder 38 and enters the choice of purchase at the touch screen 228, the controller 230 will determine the next cylinder 38 to be vended, based on its date and time of installation as stored in the memory of the controller 230. The controller 230 will then send a signal to the motor 220 to rotate the rotator assembly 50 such that the location 58 of the next determined cylinder 38 is adjacent the customer door 212 and will send another signal to the actuator 218 to allow the customer to open the customer door 212 and remove the cylinder 38 The various payment options in the credit card reader 232 and the cash, coin, or token collector 236 will utilize conventional vending and verification technology for the processing of credit card, cash, or coin payments, as will be appreciated by those skilled in the art. After the customer has completed the transaction, the printer 234 generates a hard copy receipt for the customer. Alternatively, the printer 234 could be configured to print, for example, service codes from the controller 230 during maintenance of the assembly 200.

In accordance with the provisions of the patent statutes, the present invention has been described in what is considered to represent its preferred embodiment. However, it should be noted that the invention can be practiced otherwise than as specifically illustrated and described without departing from its spirit or scope. While propane tanks or cylinders have been described, the machine according to the present invention can be used to vend any suitable item.

What is claimed is:

1. An apparatus for vending a plurality of articles, comprising:
at least one vending machine including:
an enclosure having closed sides and a hollow interior, said enclosure having a door opening formed in one of said sides,
a rotator assembly rotatably mounted in said hollow interior of said frame, said rotator assembly having a plurality of angularly spaced storage locations each for releasably retaining an article to be vended, and
at least one door member releasably closing said door opening for accessing an article to be vended and an actuator operable to allow an article to be vended from said at least one door member; and
a payment control unit connected to said at least one vending machine by a connector, said payment control unit including a customer interface, a controller and at least one means for receiving payment, said controller in communication with said customer interface and said at least one means for receiving payment, said actuator and said controller operable to receive a signal from said customer interface and process a signal from said means for receiving payment and to send a signal to said actuator on said at least one vending machine to allow an article to be vended from said at least one door member.

2. The apparatus according to claim 1 wherein said rotator assembly includes at least two article supporting trays in a stacked relationship, each of said trays having a predetermined number of said storage locations, said storage locations of one of said trays being angularly displaced with respect to said storage locations of another one of said trays.

3. The assembly according to claim 1 wherein said at least one vending machine is a plurality of vending machines.

4. The assembly according to claim 1 wherein said connector comprises a conduit for enclosing conductors or the like for transmitting signals between said controller and said at least one vending machine.

5. The assembly according to claim 1 wherein said customer interface is a touch screen.

6. The assembly according to claim 1 wherein said actuator is a locking mechanism attached to said door member and being operable to lock and unlock said door member.

7. The assembly according to claim 1 including a motor operable to rotate said rotator assembly, said motor in communication with and operable to receive a signal from said controller.

8. The assembly according to claim 7 wherein said motor is a reversible electric motor.

9. The assembly according to claim 1 wherein said at least one vending machine includes a plurality of sensors, each of said sensors being in communication with and operable to send a signal to said controller.

10. The assembly according to claim 9 wherein said sensors are a one of a proximity sensor, a door open sensor, or actuating sensor.

11. The assembly according to claim 1 wherein said controller is a one of a PLC and a PC.

12. The assembly according to claim 1 wherein said at least one means for receiving payment is a credit card reader.

13. The assembly according to claim 1 wherein said payment control unit includes a printer in communication with said controller.

14. The assembly according to claim 1 including a means for preventing rotation of said rotator assembly when said at least one door member is open.

15. An assembly for vending a plurality of propane tanks, comprising:
at least one vending machine including:
an enclosure having closed sides and a hollow interior, said enclosure having a door opening formed in one of said sides,
a rotator assembly rotatably mounted in said hollow interior of said frame, said rotator assembly having a plurality of angularly spaced storage locations each for releasably retaining a propane tank to be vended,
at least one door member releasably closing said door opening for accessing an article to be vended, an actuator operable to allow a propane tank to be vended from said at least one door member; and
a payment control unit connected to said at least one vending machine by a connector, said payment control unit including a customer interface, a controller and at least one means for receiving payment, said controller in communication with said customer interface, said at least one means for receiving payment, said actuator and said controller operable to receive a signal from said customer interface and process a signal from said means for receiving payment and to send a signal to said actuator and said motor on said at least one vending machine to allow a propane tank to be vended from said at least one door member.

16. The assembly according to claim 15 wherein said at least one door member includes a customer door and a maintenance door.

17. The assembly according to claim 15 wherein said at least one vending machine includes a plurality of sensors, each of said sensors being in communication with and operable to send a signal to said controller.

18. The assembly according to claim 16 wherein said sensors are a one of a proximity sensor, a door open sensor, or actuating sensor.

19. The assembly according to claim 15 wherein said customer interface is a touch screen.

20. The assembly according to claim 15 wherein said at least one means for receiving payment is a credit card reader.
